(19) United States
(12) Patent Application Publication
(10) Pub. No.: US 2002/0174592 A1
(43) Pub. Date: Nov. 28, 2002

(54) Fish lure

(76) Inventor: Dean Richard Wright, Poulsbo, WA (US)

Correspondence Address: Dean Wright, 23359 Clear Creek Rd. N.W., Poulsbo, WA, 98370, US

(21) Appl. No.: 09/862,195

(22) Filed: May 22, 2001

(51) Int. Cl. A01K 85/00

(52) U.S. Cl. 43/42.36

(57) ABSTRACT

A fishing lure simulating a bait fish in the form of a slender elongated body which will Sink in water and that is larger at its longitudinal center than at its ends and tapers symmetrically towards Said ends, said body being curved-shaped from the center to said ends, and curved-shaped from the center to the sides, and said sides being curved-shaped from the center to its ends.

### BACKGROUND OF THE INVENTION

This invention relates to lures to be used in catching fish.

In fishing with herring or other bait fish it is common practice to use a hook leader connection, the hook is then embedded into the head of said bait fish, with said bait fish attached to the leader and a suitable size sinker with swivels connecting the leader to the fishing line, the bait can either be mooched, trolled or cast. In such fishing there are not only problems mentioned above but valuable time is often wasted with bait and sinker tangled together. With this present lure such tangling problems are avoided: moreover, it has been found that a specially shaped lure, suggestive of most bait fish, is just as effective in catching fish as the real bait Other similar lures that are substantially diamond-shaped have been used in catching fish but with limited success. Because the diamond-shaped lure is not shaped suggestive of bait fish, and although it will spin when it moves downwardly through the water, it spins too slow, thus making it sink too fast for fish to respond. This present lure with its curved-shaped sides and curved-shaped centre, spins faster and sink slower when moving downwardly through the water, and is shaped suggestive of bait fish, thus producing the required action and shape that proves to be successful with practically all types of fish, and can be mooched, jigged, trolled or cast.

### BRIEF DESCRIPTION OF THE INVENTION

As herein disclosed the fish lure of the present invention comprises a slender elongated body shape-suggestive of a bait fish, which will sink in water and that is larger at its longitudinal center than at its ends, and tapers symmetrically towards said ends, said body is wider at any transverse plane throughout the length thereof than its thickness midway between the side edges at this plane. The said lure body is constructed with lead, plastic, rubber or the like, said lure can be made in different sizes and colors so as to match the size and color of bait fish that different fish feed on. Said lure body has a bore extending therethrough from end to end to permit a fishing line to be threaded therethrough. Said lure remains in a substantially horizontal position and rotates around its longitudinal axis as it moves downwardly through the water. This appears to trigger a response from the fish to immediately attack the lure, even when fish appear not to be hungry or feeding.

### BRIEF DESCRIPTION OF THE DRAWINGS

In drawings which illustrate an embodiment of the invention, and which describe the invention by way of Example only,

FIG. 1. Is a top view of the fish lure.

FIG. 2. Is a side view of the fish lure.

FIG. 3. Is an enlarged end elevation of lure.

FIG. 4. Is an enlarged cross section taken on line 4-4 of FIG. 2.

FIG. 5. Is an enlarged cross section taken on line 5-5 of FIG. 2.

FIG. 6. Is an enlarged fragmentary longitudinal section taken on line 6-6.

### DETAILED DESCRIPTION WITH REFERENCE TO DRAWINGS

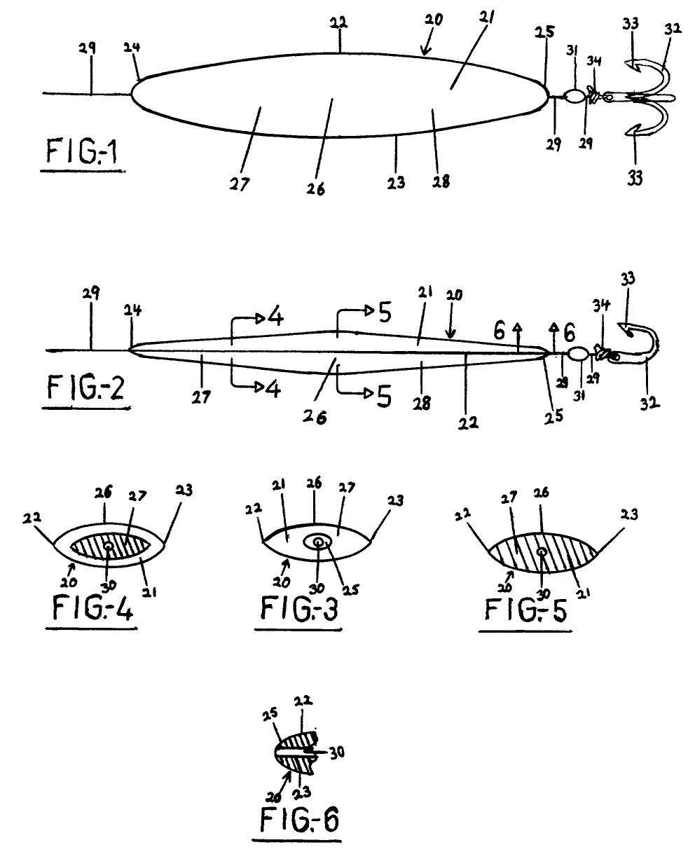

Referring to the drawings of FIGS. 1, 2, 3, 4, 5 and 6, 20 is a fish lure comprising a slender elongated body 21 which is heavy enough to sink in water, and is formed of lead, plastic, rubber, or the like. Body 21 has side edges 22 and 23 extending between its ends 24 and 25. Said body is larger at its longitudinal center, as indicated at 26, than said ends 24 and 25, and tapers symmetrically towards said ends 24 and 25, so that said body 21, is formed with forwardly and rearwardly inwardly tapering sections 27 and 28. By referring to FIGS. 1 and 2, it will be seen that the body of illustrated lure 20, is wider at its central section 26, than its thickness at said ends 24 and 25. By referring to FIGS. 3, 4 and 5, it will be seen that in each case said body is wider than its central thickness at the respective section planes. This applies to said body throughout the length thereof By referring to FIGS. 1, 2, 3, 4 and 5, said body is curved-shaped from the centre 26 to said ends 24 and 25, and curved-shaped from said centre 26 to the sides 22 and 23, said sides 22 and 23 being curved-shaped from said centre 26, to its ends 24 and 25. By referring to FIGS. 3, 4, and 5, it is to be noted that side edges 22 and 23, are thin and blade-like. By referring to FIGS. 1, 2, 3, and 6, it is to be noted that each end of said body 24 and 25, are convexly rounded in a substantially circular arc. By referring to FIGS. 1, 2, 3, 4, 5 and 6, said lure body 21 is formed with a bore 30, extending longitudinally from end to end 24 and 25 thereof said bore 30 being large enough in cross section to permit a fishing line 29, to be threaded therethrough. In FIGS. 1 and 2, said fishing line 29, is threaded through bore 30, and threaded through a bead 31, and line 29, is tied 34, to a fish hook 32, said fish hook 32, can be either a treble hook or a singular hook with or without barbs 33, weedless type or not. Fish line 29, extends to fishing rod and reel not shown. Since it is obvious that numerous changes and modifications can be made in the above-described details without deparing from the spirit and nature of the invention, it is to be understood that all such changes and modifications are included within the scope of the invention.

The embodiments of the invention which an exclusive property or privilege is claimed are as defined as follows:

1. A fish lure comprising a slender elongated body that will sink in water and having side edges extending between ends thereof, said body being larger at its longitudinal centre than at said ends and tapering symmetrically towards the ends, and said body being wider at any transverse plane throughout the length thereof than its thickness substantially midway between the side edges at any transverse plane.

2. A fish lure defined in claim 1 wherein said body is larger in both width and thickness at its longitudinal centre than at the ends, and tapers symmetrically in both width and thickness towards said ends.

3. A fish lure as defined in claims 1 or 2 wherein said body has a bore extending therethrough from end to end thereof, said bore being large enough in cross section to permit a fishing line to be threaded therethrough.

4. A fish lure as defined in claim 1 wherein said body is substantially larger at its longitudinal center than its ends and tapers symmetrically towards said ends.

5. A fish lure as defined in claim 4 wherein said body being curved-shaped from the centre to the ends and curved-shaped from said center to the sides.

6. A fish hire as defined in claim 4 wherein said side edges of the body are thin and blade-like.

7. A fish lure as defined in claim 4 wherein each end of the body are convexly rounded in a substantially circular arc.

8. A fish lure as defined in claim 1 wherein having a slender elongated body that will rotate around its longitudinal central axis as said body moves downwardly in the water.

9. A fish lure as defined in claim 8 wherein said body is formed symmetrically around the longitudinal axis thereof and generally tapers inwardly towards said ends of the body.

10. A fish lure as defined in claim 8 wherein said body is wider than it is thick at its longitudinal centre and tapers inwardly in both horizontal and vertical planes.

11. A fish lure as defined in claim 8 wherein said body is wider at any transverse plane throughout the length thereof than its thickness substantially midway between side edges thereof at said any plane.

12. A fish lure as defined in claim 9 wherein said body is wider than it is thick at its longitudinal centre and tapers inwardly in both horizontal and vertical planes.

13. A fish lure as defined in claim 9 wherein said body is wider at any transverse plane throughout the length thereof than its thickness substantially midway between side edges thereof at said any plane.
